(19) United States
(12) Patent Application Publication
(10) Pub. No.: US 2025/0186911 A1
(43) Pub. Date: Jun. 12, 2025

(54) FILTER CARTRIDGE WITH OFFSET OUTLET AND INTEGRATED BYPASS

(71) Applicant: Cummins Filtration Inc., Nashville, TN (US)

(72) Inventors: Gerard Malgorn, Ergué-Gabéric (FR); Vaibhav Pimpalte, Pune (IN); Wassem Abdalla, Fishers, IN (US)

(73) Assignee: Cummins Filtration Inc., Nashville, TN (US)

(21) Appl. No.: 18/844,366

(22) PCT Filed: Mar. 2, 2023
(86) PCT No.: PCT/US2023/014361

§ 371 Date: Sep. 5, 2024

Related U.S. Application Data
(60) Provisional application No. 63/318,077, filed on Mar. 9, 2022.

(51) Int. Cl. B01D 29/15; B01D 27/10; B01D 35/00; B01D 36/00

(52) U.S. Cl. CPC B01D 29/15; B01D 27/103; B01D 36/001; B01D 35/005; B01D 2201/0415; B01D 2201/291; B01D 2201/302; B01D 2201/316

(57) ABSTRACT

A filter cartridge includes a media pack defining a central cavity, a first endcap coupled to a first pack end of the media pack, and a second endcap coupled to a second pack end of the media pack. The second endcap includes a first conduit extending axially away from the media pack and fluidly coupled to the central cavity, and a second conduit extending axially away from the media pack and spaced apart from the first conduit. A first conduit axis of the first conduit and a second conduit axis of the second conduit are each radially offset from a central axis of the central cavity.

### CROSS-REFERENCE TO RELATED PATENT APPLICATIONS

The present application is a National Stage of PCT Application No. PCT/US2023/014361, Mar. 2, 2023, which claims the benefit of and priority to U.S. Patent Application No. 63/318,077, filed Mar. 9, 2022. The contents of these applications are hereby incorporated by reference in their entirety.

### TECHNICAL FIELD

The present disclosure generally relates to filtration systems for internal combustion engine systems.

### BACKGROUND

Internal combustion engine systems require various fluids (e.g., lubricating oil, fuel, etc.) to operate. The fluids are generally passed through a filter cartridge to remove water and other contaminants. The filter cartridge may form part of a multi-piece filter assembly that includes a housing sized to receive the filter cartridge therein and to engage the filter cartridge with other parts of the internal combustion engine system. The filter assembly may also include valves to control the flow of fluids through the filter cartridge. For example, the housing may include a bypass valve separate from the filter cartridge that allows dirty fluid to bypass the filter cartridge in the event that the filter cartridge becomes clogged. The housing may also include an anti-drain back valve to prevent fluid from draining out of the filter cartridge when the engine is shut down, and to allow the engine to receive oil or fuel from the filtration system upon startup.

### SUMMARY

One embodiment of the present disclosure relates to a filter cartridge. The filter cartridge includes a media pack defining a central cavity, a first endcap coupled to a first pack end of the media pack, and a second endcap coupled to a second pack end of the media pack. The second endcap includes a first conduit extending axially away from the media pack and fluidly coupled to the central cavity, and a second conduit extending axially away from the media pack and spaced apart from the first conduit. A first conduit axis of the first conduit and a second conduit axis of the second conduit are each radially offset from a central axis of the central cavity.

Another embodiment of the present disclosure relates to a filtration system. The filtration system includes a standpipe and a filter cartridge. The filter cartridge includes a media pack defining a central cavity, a first endcap disposed at a first pack end of the media pack, and a second endcap disposed at a second pack end of the media pack. The second endcap defines a first opening and a second opening spaced radially apart from the first opening. The standpipe extends through the second opening and into the central cavity. The standpipe is engaged with the first endcap to form one of a bypass valve or an air vent for the filtration system.

Yet another embodiment of the present disclosure relates to a method of installing a filter cartridge into a housing. The method includes (i) aligning a first conduit of the filter cartridge located at a first radial position that is offset from a central axis of the filter cartridge with a standpipe of the housing; (ii) inserting the standpipe into the first conduit and into a central cavity of the filter cartridge; and (ii) inserting a second conduit of the filter cartridge located at a second radial position that is offset from the central axis of the filter cartridge into an outlet port of the housing.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is side cross-sectional view of a filtration system in a first operating state, according to an embodiment.

FIG. 2 is a side cross-sectional view of the filtration system of FIG. 1 in a second operating state.

FIG. 3 is an exploded side view of the filtration system of FIG. 1.

FIGS. 4-5 are exploded perspective views of the filtration system of FIG. 1.

FIG. 6 is a top view of a filter cartridge usable with the filtration system of FIG. 1, according to an embodiment.

FIG. 7 is a perspective view of the filter cartridge of FIG. 6.

FIG. 8 is a side cross-sectional view of the filter cartridge of FIG. 6.

FIG. 9 is a bottom view of the filter cartridge of FIG. 6.

FIG. 10 is a side cross-sectional view of an upper housing portion usable with the filtration system of FIG. 1, according to an embodiment.

FIG. 11 is a perspective view of the upper housing portion of FIG. 10.

FIG. 12 is a bottom view of the upper housing portion of FIG. 10.

FIG. 13 is a perspective view of a piston element usable with the upper housing portion of FIG. 10, according to an embodiment.

FIG. 14 is a side view of the piston element of FIG. 13.

FIGS. 15-17 are side cross-sectional views of the filtration system of FIG. 1, showing different stages of assembly of the filtration system.

FIG. 18 is side cross-sectional view of a portion of a filtration system in a first operating state, according to an embodiment.

FIG. 19 is a side cross-sectional view of the portion of the filtration system of FIG. 18 in a second operating state.

FIG. 20 is a partially exploded side cross-sectional view of the portion of the filtration system of FIG. 18.

FIG. 21 is a partially exploded perspective view of the portion of the filtration system of FIG. 18.

FIGS. 22-24 are perspective views of an intermediate assembly usable with the filtration system of FIG. 18, according to an embodiment.

FIG. 25 is a side cross-sectional view of the intermediate assembly of FIGS. 22-24.

FIGS. 26-27 are perspective views of a filter cartridge usable with the filtration system of FIG. 18, according to an embodiment.

FIG. 28 is a side cross-sectional view of the filter cartridge of FIGS. 26-27.

FIGS. 29-31 are side cross-sectional views of the portion of the filtration system of FIG. 18 showing different stages of assembly of the filtration system.

FIG. 32 is a side cross-sectional view of a portion of a filtration system, according to another embodiment.

FIG. 33 is a top view of a filter cartridge usable with the filtration system of FIG. 32, according to an embodiment.

FIG. 34 is a perspective view of the filter cartridge of FIG. 33.

FIG. 35 is a side cross-sectional view of the filter cartridge of FIG. 33.

FIG. 36 is a bottom view of the filter cartridge of FIG. 33.

FIG. 37 is a side cross-sectional view of an intermediate assembly usable with the filtration system of FIG. 32.

FIG. 38 is a side cross-sectional view of a portion of a filtration system, according to yet another embodiment.

FIG. 39 is a perspective view of the portion of the filtration system of FIG. 38.

FIG. 40 is a side cross-sectional view of a filter cartridge usable with the filtration system of FIG. 38, according to an embodiment.

FIG. 41 is a perspective view of the filter cartridge of FIG. 40.

FIG. 42 is a perspective view of an intermediate assembly usable with the filtration system of FIG. 38, according to an embodiment.

FIG. 43 is a bottom view of the intermediate assembly of FIG. 42.

FIG. 44 is a side cross-sectional view of the intermediate assembly of FIG. 42.

FIG. 45 is side cross-sectional view of a filtration system in a first operating state, according to yet another embodiment.

FIG. 46 is a side cross-sectional view of the filtration system of FIG. 45 in a second operating state.

FIGS. 47-48 are side cross-sectional views of the filtration system of FIG. 45 showing different stages of assembly of the filtration system.

FIG. 49 is a perspective view of a filter cartridge usable with the filtration system of FIG. 45, according to an embodiment.

FIG. 50 is a side view of the filter cartridge of FIG. 49.

FIG. 51 is a top view of the filter cartridge of FIG. 49.

FIG. 52 is a side cross-sectional view of the filter cartridge of FIG. 49.

FIG. 53 is a perspective view of an upper housing portion usable with the filtration system of FIG. 45, according to an embodiment.

FIG. 54 is a bottom view of the upper housing portion of FIG. 53.

FIG. 55 is a side cross-sectional view of the upper housing portion of FIG. 53.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to filtration systems for fuel and lube filtration applications. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

The present application generally relates to filtration systems that includes a filter cartridge and a fluid bypass valve that is at least partially integrated into the filter cartridge. The bypass valve may be part of a standpipe that extends into the filter cartridge when the filter cartridge is installed into a housing of the filtration system. The filter cartridge may be structured so that the bypass valve is offset from a central axis of the filter cartridge which can, advantageously, reduce flow restriction through the filter cartridge by providing a larger space for fluid to pass through the filter cartridge. Positioning the bypass valve within the filter cartridge can also eliminate the need for a separate bypass valve in the housing, and can thereby reduce the overall footprint of the filtration system.

The filter cartridge may engage the housing via endcaps at either end of the filter cartridge. The first cartridge may include a first endcap at a first pack end of a media pack and a second endcap at a second pack end of the media pack. The second endcap may include a first conduit structured to engage a standpipe of the housing, and a second conduit structured to engage an outlet port of the housing. The first endcap may include a through-hole opening structured to engage a valve member of the bypass valve within the standpipe. The through-hole opening may be coaxially aligned with the first conduit to reduce the risks of fluid leakage between the valve member and the first endcap when the filter cartridge is installed into the housing.

In at least one embodiment, the filter cartridge is structured to connect to the outlet port and the standpipe of the housing via unidirectional movement (e.g., axial movement) of the filter cartridge relative to the housing. The first and second conduits may each extend axially away from the media pack and may be spaced radially apart from one another along the endcap. A central axis of each of the first conduit and the second conduit may be radially offset from a central axis of the central cavity. In this way, the first conduit and the second conduit can connect to different parts of the housing (e.g., the standpipe and the outlet port) independent from one another.

In at least one embodiment, the first conduit defines an oval-shaped opening that is sized to receive an oval-shaped standpipe therein. The standpipe may have a geometry that is complementary with (e.g., matches) the oval-shaped opening. Beneficially, using oval shapes for both the standpipe and the first conduit opening can simplify the alignment process between the filter cartridge and the housing during installation relative to other circular and non-circular shapes. Additionally, the geometry of the oval shape of the opening and the standpipe may be adjusted to prevent the use of non-genuine filter element cartridges in the filtration system, which may not be designed to the same specifications as genuine filter cartridges, and may not provide the same level of engine protection as genuine filtration cartridges.

In some embodiments, the filter cartridge may be structured to bypass an anti-drain back valve of the filtration system when servicing the filter cartridge so as to allow dirty fluid to discharge from the filtration system. The housing may include an inlet passageway that provides dirty fluid to the filter cartridge and an outlet passageway that fluidly couples a clean side of the filter cartridge to the engine. The second conduit may engage an inlet port of the housing that fluidly couples the inlet passageway to a hollow interior of the housing. The second conduit may seal the port when the filter cartridge is fully installed into the housing. During service events, when the filter cartridge is removed from the housing, the second conduit disengages the port to allow dirty fluid to discharge from the filtration system. Bypassing the anti-drain back valve during service events can reduce the amount of dirty fluid remaining in the filtration system after installing a new filter cartridge, which can improve the life of the engine, gear box, E-axle, and/or other components of the engine system.

### II. Example Filtration System

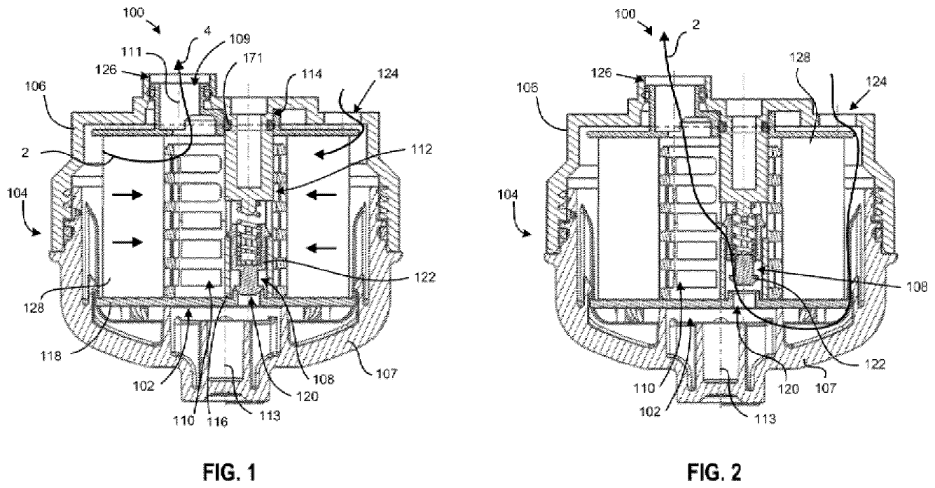

FIGS. 1-2 show a filtration system 100, according to an embodiment. The filtration system 100 may be used to filter a fluid provided to an internal combustion engine. The fluid may be a fuel, an engine oil, a hydraulic oil, or another lubricant. For example, the filtration system 100 may be a lube oil filtration system for an internal combustion engine that removes particulate matter and other contaminants from a lubrication system of the internal combustion engine. The internal combustion engine may be a diesel engine, a gasoline engine, a natural gas engine, a dual fuel engine, a biodiesel engine, an E85 engine, a flex fuel engine, a gas turbine, or another type of internal combustion engine or driver. In other embodiments, the filtration system 100 may be used as part of a lubrication system for a pump, a hydraulic system, or another type of system or device.

As shown in FIGS. 1-2, the filtration system 100 (e.g., filter assembly, filter module, etc.) includes a filter cartridge 102 and a housing 104 structured to receive the filter cartridge 102 therein. The housing 104 may include a housing first portion 106 (e.g., an upper portion as shown in FIGS. 1-2) and a housing second portion 107 (e.g., a lower portion as shown in FIGS. 1-2) structured to secure the filter cartridge 102 to the housing first portion 106. The housing second portion 107 may be threadably engaged with the housing first portion 106 and may be removable from the housing first portion 106 to replace the filter cartridge 102.

The filter cartridge 102 may be removably coupled to the housing second portion 107. As shown in FIG. 1, the housing 104 (e.g., the housing first portion 106) is structured to direct dirty fluid toward a dirty side of the filter cartridge 102 and to direct clean fluid away from a clean side of the filter cartridge 102 toward the internal combustion engine.

In at least one embodiment, the filtration system 100 also includes a bypass valve 108 that is disposed within the filter cartridge 102. The bypass valve 108 (e.g., pressure relief valve, etc.) is structured to open when the filter cartridge 102 becomes clogged or when the pressure drop across the filter cartridge 102 increases above a pressure threshold. In this way, the bypass valve 108 can ensure that the internal combustion engine or other system receives sufficient oil to continue operation, and can reduce the risks of leaks forming due to increased pressure in the filtration system 100.

As shown in FIG. 1, the bypass valve 108 is disposed within a central cavity 110 of the filter cartridge 102 when the filter cartridge 102 is installed onto the housing first portion 106 of the housing 104. In at least one embodiment, the bypass valve 108 is at least partially integrated into a standpipe 112 (e.g., center tube, etc.) of the housing first portion 106 that is received within the filter cartridge 102. The standpipe 112 may engage a first endcap 118 of the filter cartridge 102 to form one of (i) the bypass valve or (ii) an air vent for the filter cartridge 102 or filtration system, as will be further described. The bypass valve 108 and the standpipe 112 (e.g., a central axis of the bypass valve 108 and the standpipe 112) may be radially offset from a central axis 113 of the central cavity 110 of the filter cartridge 102 which can, advantageously, reduce flow restriction through the central cavity 110 by providing a larger unimpeded cross-section for flow through the central cavity 110.

As shown in FIG. 1, the standpipe 112 extends into the central cavity 110, and across an entire axial length of the central cavity 110, when the filter cartridge 102 is fully installed onto and/or into the housing 104 (e.g., when the filter cartridge 102 is fully engaged with the housing first portion 106, when the filter cartridge 102 is sealingly engaged with the housing first portion 106, etc.). In the embodiment of FIG. 1, a portion of the bypass valve 108 engages a first endcap 118 of the filter cartridge 102, at a through-hole opening 120 of the first endcap 118, when the filter cartridge 102 is fully installed onto the housing 104. In some embodiments, a distal end 116 of the standpipe 112 may also engage a first endcap 118 of the filter cartridge 102 when the filter cartridge 102 is fully installed onto the housing 104. In other embodiments, the distal end 116 of the standpipe 112 may be spaced axially apart from the first endcap 118 when the filter cartridge 102 is fully installed onto the housing 104. In some embodiments, the distal end 116 of the standpipe 112 at least partially surrounds (e.g., circumscribes) and/or engages a protrusion of the first endcap 118 that defines a bypass sealing seat for the bypass valve 108 (e.g., a valve seat, etc.).

As shown in FIG. 1, the filter cartridge 102 also includes an outlet opening 109 that is structured to direct clean fluid away from the filter element and toward the housing first portion 106 (e.g., toward an outlet port of the first portion, etc.). The outlet opening 109 (e.g., a first opening, etc.) is spaced radially apart from a standpipe opening 114 (e.g., a second opening, etc.) at which the standpipe 112 engages the filter cartridge 102. A central axis 111 of the outlet opening 109 is radially offset from the central axis 113 of the central cavity 110. The outlet opening 109 may be substantially axially aligned with an open portion of the central cavity 110 that extends alongside the bypass valve 108, so that the central axis 111 of the outlet opening 109 is proximate to a center of the open portion (e.g., a centroid of the cross-sectional area of the open portion, etc.), which can reduce flow restriction through the filter cartridge 102.

As shown in FIGS. 1-2, the bypass valve 108 is movable between a closed position (as shown in FIG. 1) in which the portion of the bypass valve 108 (e.g., a piston element 122) sealingly engages the first endcap 118, and an open position (shown in FIG. 2) in which the portion of the bypass valve 108 (e.g., the piston element 122) is spaced axially apart from the first endcap 118.

As shown in FIG. 1, when the bypass valve 108 is in the closed position, dirty fluid 2 entering through an inlet port 124 of the housing first portion 106 passes through the filter cartridge 102 to form a clean, filtered fluid 4. The filtered fluid 4 is then directed to the internal combustion engine through an outlet port 126 in the housing first portion 106. In the event that the filter cartridge 102 (e.g., a media pack 128) becomes clogged, or the pressure drop across the filter cartridge 102 otherwise exceeds a pressure threshold, the bypass valve 108 switches automatically from the closed position to the open position. As shown in FIG. 2, when the bypass valve 108 is in the open position, the dirty fluid 2 may bypass the filter cartridge 102 (e.g., the media pack 128) via the through-hole opening 120 of the first endcap 118. In this way, the filtration system 100 can reduce the risk of over-pressurizing the filtration system 100 and prevent oil starvation in the internal combustion engine that could result from reduced flow rates through the filter cartridge 102 (e.g., the media pack 128).

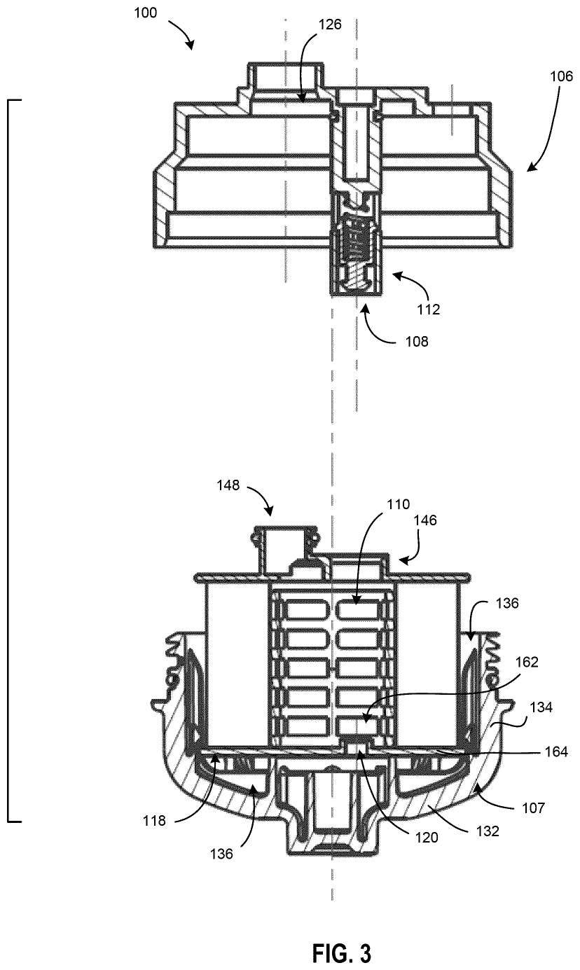

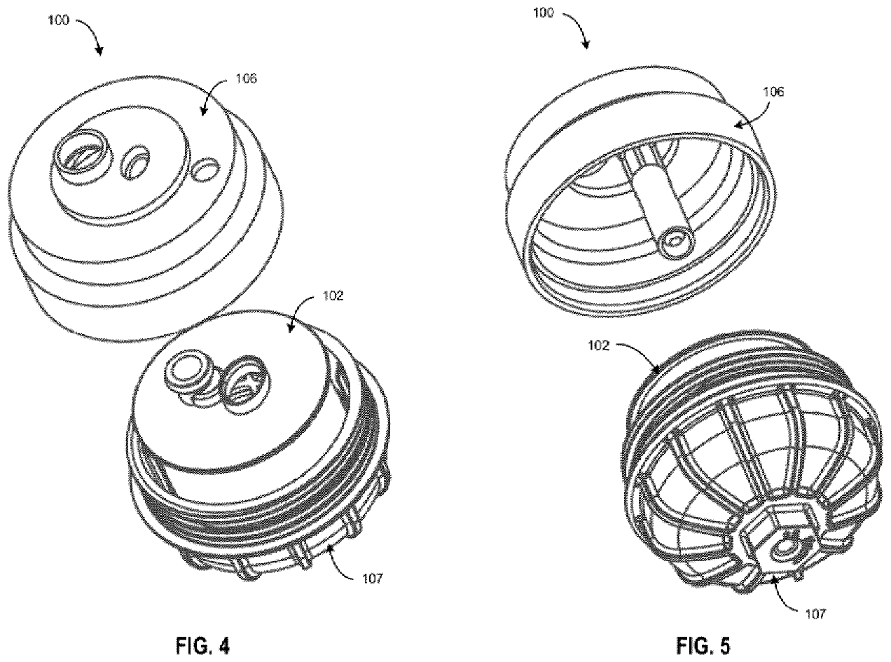

FIGS. 3-5 show a partially exploded view of the filtration system 100 of FIGS. 1-2. The filter cartridge 102 is removably coupled to the housing first portion 106 by the housing second portion 107 of the housing 104. The filter cartridge 102 is also removably coupled to the housing second portion 107. For example, the housing second portion 107 may include snaps, clips, or another suitable fastener that engages the first endcap 118 of the filter cartridge 102 (e.g., along a perimeter of the first endcap 118, etc.) when the filter cartridge 102 is pressed against the housing second portion 107.

As shown in FIG. 3, the housing second portion 107 of the housing 104 includes a second portion base wall 132 and a cylindrically-shaped second portion sidewall 134 extending axially away from the second portion base wall 132 in a substantially perpendicular orientation relative to the second portion base wall 132. The second portion base wall 132 and the second portion sidewall 134 together define a first portion of a hollow interior 136 of the housing 104 that is sized to receive the filter cartridge 102 therein. The housing second portion 107 also includes a threaded interface at an upper end of the second portion sidewall 134. In other embodiments, the shape of the housing second portion 107 may be different.

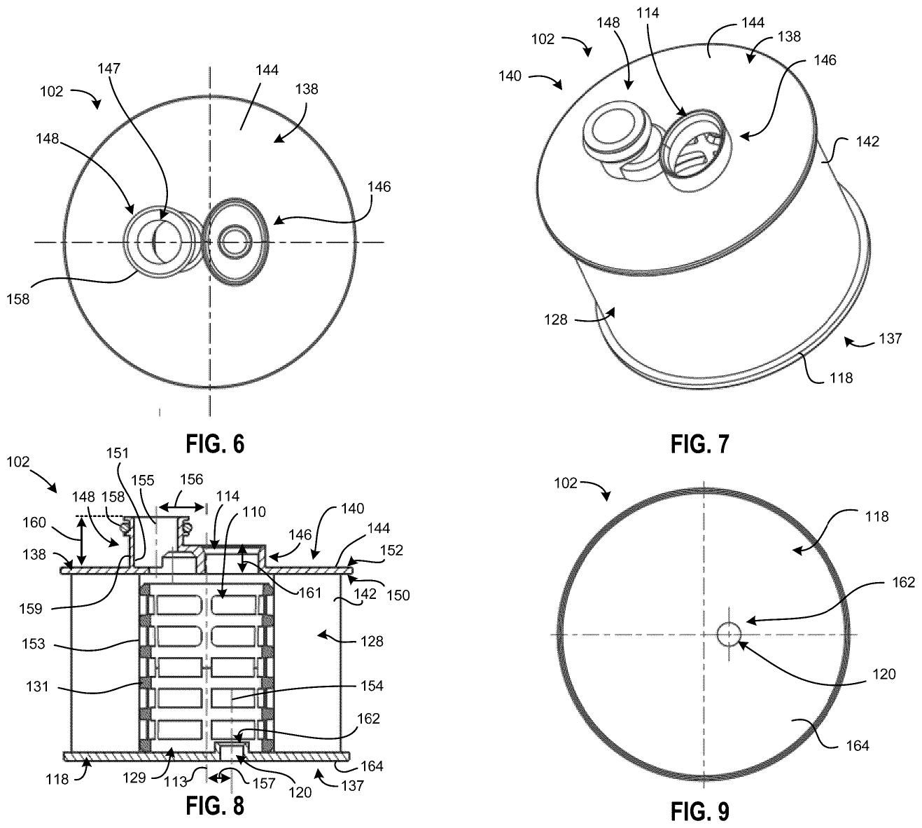

As shown in FIG. 3, the filter cartridge 102 includes two separate connection points that sealingly engage with the housing first portion 106 at separate locations along the housing first portion 106. FIGS. 6-9 show various views of the filter cartridge 102, according to an embodiment. The filter cartridge 102 includes the media pack 128, a support structure 129, a first endcap 118 disposed at and coupled to a first pack end 137 of the media pack 128, and a second endcap 138 disposed at and coupled to a second pack end 140 of the media pack 128. As shown in FIG. 8, the media pack 128 is formed in a cylindrical shape defining a central cavity 110. In other embodiments, the shape of the media pack 128 may be different. The media pack 128 includes filter media 142 structured to filter particulate matter from fluid flowing therethrough to produce a filtered fluid (e.g., a clean fluid). The filter media 142 may include a porous material having a predetermined pore size. The filter media 142 may include a paper-based filter media, a fiber-based filter media, or the like. The filter media 142 may be pleated or formed into another desired shape to increase a flow area through the media pack 128, or to otherwise alter the particle removal efficiency of the filter cartridge 102. In the example of FIGS. 6-9, the filter cartridge 102 is arranged as an outside-in flow filter element having an outer dirty side and an inner clean side. Fluid to be filtered passes from the dirty side of the filter cartridge 102 to the clean side of the filter cartridge 102.

As shown in FIG. 8, the first endcap 118 and the second endcap 138 are sealingly engaged to the media pack 128 at opposing axial ends of the media pack 128 to prevent fluid bypass between the clean and dirty sides of the filter cartridge 102. The second endcap 138 is structured to sealingly engage the filter cartridge 102 with the housing first portion 106 of the housing 104.

The second endcap 138 includes a disc-shaped base wall 144 that is sealingly engaged with the media pack 128 on a first base end 150 of the base wall 144. The second endcap 138 also includes a first conduit 146 (e.g., a first connection) and a second conduit 148 (e.g., a second connection) that are engaged with a second base end 152 of the base wall 144 and extend axially away from the base wall 144 and the media pack 128. In the embodiment of FIG. 8, the first conduit 146 and the second conduit 148 are integrally formed with the base wall 144 as a single unitary/monolithic piece (e.g., via injection molding or another suitable operation). In other embodiments, the first conduit 146 and the second conduit 148 may be formed separately from the base wall 144 and may be coupled to the base wall 144.

As shown in FIG. 8, the first conduit 146 and the second conduit 148 comprise flow conduits (e.g., tubes, pipes, etc.) that are both fluidly coupled to the central cavity 110. The first conduit 146 forms a standpipe opening 114 that is sized to receive the standpipe 112 therein (e.g., an oval-shaped opening). The second conduit 148 may be an outlet conduit that is structured to direct clean fluid out of the central cavity 110 on the clean side of the filter cartridge 102 and into the housing first portion 106.

As shown in FIG. 8, the first conduit 146 and the second conduit 148 are spaced apart from one another along the base wall 144 (e.g., spaced radially apart from one another with respect to the central axis 113 of the central cavity 110). A conduit axis (e.g., a first central axis, a second central axis, etc.) of each of the first conduit 146 and the second conduit 148 (e.g., a first conduit axis 154 of the first conduit 146 and a second conduit axis 155 of the second conduit 148 as shown in FIG. 8) is radially offset from the central axis 113 of the central cavity 110.

As shown in FIG. 8, the second conduit 148 may be spaced radially apart from the central axis 113 of the central cavity 110 by a first distance 156 that is greater than a second distance 157 between the first conduit 146 and the central axis 113. The second conduit 148 may be positioned radially inboard from the media pack 128 (e.g., so that an inner perimeter 151 of the second conduit 148 does not protrude beyond an inner perimeter 153 of the media pack 128) to ensure adequate clearance between the standpipe 112 and the media pack 128 during assembly. In other embodiments, as shown in FIG. 8, a portion 159 of an outer wall of the second conduit 148 may be disposed above the media pack 128 (e.g., axially aligned with the media pack 128, so that the inner perimeter 151 of at least a portion of the second conduit 148 extends radially outwardly beyond the inner perimeter 153 of the media pack 128) to provide more space for individual sealing interfaces of both the first conduit 146 and the second conduit 148 without substantially reducing the cross-sectional area of the second conduit 148. As shown in FIG. 8, an axial height 160 of the second conduit 148 is greater than an axial height 161 of the first conduit 146 to accommodate the offset outlet position and to provide adequate clearance for the sealing surfaces of the first conduit 146.

The first conduit 146 defines a female fitting that is structured to receive the standpipe 112 therein (see FIG. 1). As shown in FIGS. 7-8, the first conduit 146 include a tapered surface at a distal end of the first conduit 146 that facilitates alignment between the standpipe 112 and the first conduit 146 during assembly. As shown in FIG. 6, the first conduit 146 defines an oval-shaped standpipe opening 114 extending through the second endcap 138. In some embodiments, the standpipe opening 114 may be formed in an elliptical shape that is symmetrical about its central axis. In other embodiments, the standpipe opening 114 may be formed in an egg or oblong shape that is not symmetric about its central axis. Beneficially, using oval shapes for the first conduit 146 and standpipe opening 114 can simplify the alignment process between the filter cartridge 102 and the housing 104 during assembly relative to other circular and non-circular shapes. Additionally, the geometry of the oval shape of the first conduit 146 and the standpipe opening 114 may be adjusted to prevent the use of non-genuine filter element cartridges in the filtration system, which may not be designed to the same specifications as genuine filter cartridges, and may not provide adequate filtration performance as compared to genuine filter cartridges. In other embodiments, the size and/or shape of the first conduit 146 may be different.

As shown in FIGS. 7-8, the second conduit 148 defines a male fitting that is structured to insert into the outlet port 126 of the housing 104 (e.g., housing first portion 106 as shown in FIG. 3). The second conduit 148 includes a sealing member 158 (e.g., O-ring) at a distal end of the second conduit 148 to sealingly engage the second conduit 148 with the housing 104. As shown in FIG. 6, the second conduit 148 is a cylindrically-shaped extension defining a circular opening 147. In other embodiments, the size and/or shape of the second conduit 148 may be different.

As shown in FIGS. 8-9, the first endcap 118 includes a disc-shaped base wall 164 that is sealingly engaged with the media pack 128. The first endcap 118 also includes a bypass sealing seat 162 (e.g., a valve seat, etc.) that extends axially away from the base wall 164 and toward the second endcap 138. The bypass sealing seat 162 defines a through-hole opening 120 that extends through the first endcap 118. As shown in FIG. 3, the through-hole opening 120 fluidly couples the central cavity 110 with the hollow interior 136 of the housing 104.

As shown in FIG. 3, the bypass sealing seat 162 is structured to engage with a portion of the standpipe 112 to form the bypass valve 108 for the filtration system 100. As shown in FIG. 8, the bypass sealing seat 162 includes a substantially cylindrical protrusion engaged with and extending away from the base wall 164 of the first endcap 118 in a substantially perpendicular arrangement relative to the base wall 164. In some embodiments, the bypass sealing seat 162 may be integrally formed with the base wall 164 of the first endcap 118 as a single unitary/monolithic piece (e.g., via injection molding or another suitable operation). In other embodiments, the bypass sealing seat 162 is a formed separately from the base wall 164 and is coupled to the base wall 164.

The cylindrical protrusion of the bypass sealing seat 162 is tapered at a distal end of the protrusion to facilitate alignment with a portion of the bypass valve 108 in the standpipe 112. As shown in FIG. 8, the through-hole opening 120 is arranged coaxially with the first conduit 146 such that the through-hole opening 120 is disposed at the same radial and circumferential position as the first conduit 146 with respect to the central axis 113 of the central cavity 110. In this way, the first conduit 146 guides a distal end of the standpipe 112 toward the through-hole opening 120 (and bypass sealing seat 162) during installation of the filter cartridge 102 into the housing 104.

It should be appreciated that the design of the bypass sealing seat 162 may be different in various embodiments. For example, in some embodiments, the bypass sealing seat 162 may be formed directly into the base wall 164, as a tapered edge around the perimeter of the through-hole opening 120. In other embodiments, the first endcap 118 may also include ribs or other support members to improve the strength of the bypass sealing seat 162.

As shown in FIG. 8, the filter cartridge 102 also includes a support structure 129 disposed within the central cavity 110 of the media pack 128. The support structure 129 extends along an entire axial length of the central cavity 110 and engages the media pack 128 to provide support against radial loading and help prevent collapse of the media pack 128. In the embodiment of FIG. 8, the support structure 129 includes a perforated center tube 131 (e.g., a cylindrically-shaped center tube, etc.) having lateral and radial support members that are integrally formed into a single unitary/monolithic piece (e.g., via injection molding or another suitable operation). In other embodiments, the size and/or shape of the support structure 129 may be different.

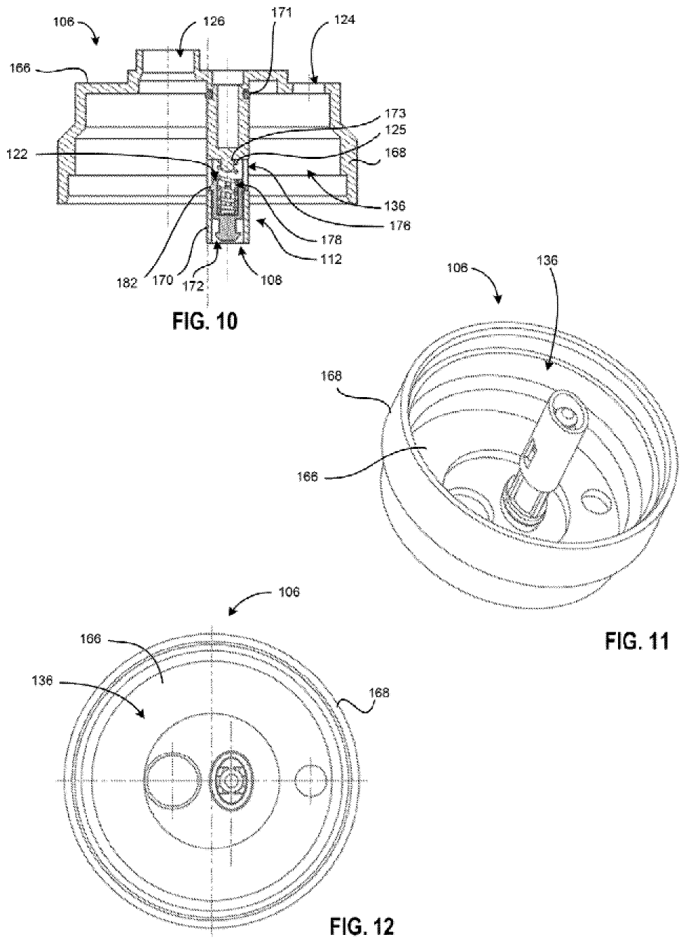

FIGS. 10-12 show various views of the housing first portion 106 of the housing 104 (see also FIG. 3), according to an embodiment. The housing first portion 106 includes a body base wall 166 and a cylindrically shaped body sidewall 168 extending away from the body base wall 166 in a substantially perpendicular orientation relative to the body base wall 166. The body base wall 166 and the body sidewall 168 together define a second portion of the hollow interior 136 of the housing 104. The body sidewall 168 also includes a threaded interface at a lower end of the body sidewall 168 that is configured to threadably engage the threated interface of the housing second portion 107. In other embodiments, the shape of the housing first portion 106 may be different.

The housing first portion 106 is structured to direct a flow of fluid both toward and away from the filter cartridge 102. As shown in FIG. 10, the housing first portion 106 includes an inlet port 124 and an outlet port 126 that are each disposed in the body base wall 166 and extend axially through the body base wall 166. In other embodiments, the inlet port 124 may be disposed along the body sidewall 168.

The housing first portion 106 also includes a standpipe 112 coupled to the body base wall 166 and extending axially away from the body base wall 166. The standpipe 112 is spaced apart (e.g., radially) from the outlet port 126. As shown in FIG. 10, the standpipe 112 comprises an extension 170 (e.g., a protrusion, etc.) having an oval-shaped cross-section that matches the shape of the standpipe opening 114 of the filter cartridge 102 (see FIG. 3). The extension 170 protrudes axially beyond a lower end of the body sidewall 168, although the axial length of the extension 170 may be different in other embodiments. In some embodiments, the extension 170 is tapered from a first radius at proximal end of the standpipe 112 (adjacent to the body base wall 166) to a second radius at the distal end 116 of the standpipe 112 that is smaller than the first radius. As shown in FIG. 10, the housing first portion 106 also includes a standpipe sealing member 171 (e.g., O-ring, gasket, etc.) disposed in a groove in the proximal end of the extension 170 and is structured to sealingly engage the standpipe 112 with the first conduit 146 of the filter cartridge 102 (see FIG. 1).

A portion of the bypass valve 108 is integrated into the standpipe 112. As shown in FIG. 10, the extension 170 defines a hollow cavity 172 at the distal end of the standpipe 112 that is sized to receive a piston element 122 therein. The standpipe 112 also includes a pair of openings 176 that fluidly couple the hollow cavity 172 to a space surrounding the standpipe 112 (e.g., to the central cavity 110 of the filter cartridge 102 as shown in FIG. 1). The pair of openings 176 extends radially through an outer wall of the extension 170. The extension 170 also includes a central protrusion 173 (e.g., nipple, spring retainer, etc.) extending axially into the hollow cavity 172 and configured to support a spring used to maintain the bypass valve 108 in compression against the bypass sealing seat 162.

The bypass valve 108 (e.g., bypass valve assembly) is at least partially disposed within the standpipe 112. As shown in FIG. 10, the bypass valve 108 includes a piston element 122 and a spring element 125 (e.g., compression spring, etc.) disposed within the hollow cavity 172. The spring element 125 is configured to apply an axial force to the piston element 122 to maintain the piston element 122 in compression against the bypass sealing seat 162 of the filter cartridge 102 (see FIG. 8). As shown in FIG. 10, the spring element 125 is disposed axially between the central protrusion 173 and the piston element 122 and extends into a hollow interior region 178 of the piston element 122.

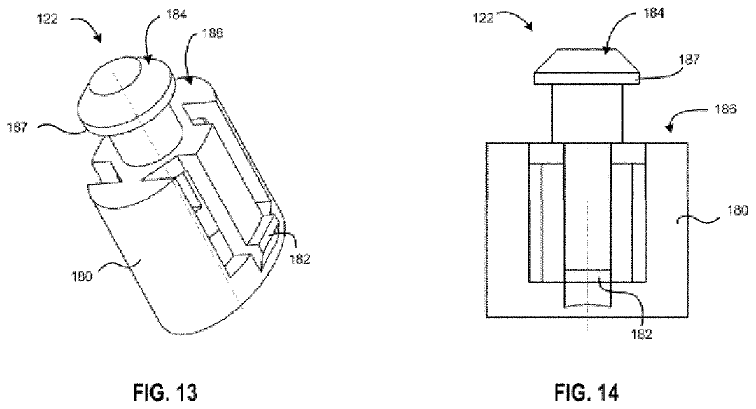

The piston element 122 is slidably engaged with the extension 170. FIGS. 13-14 show perspective and side views, respectively, of the piston element 122. The piston element 122 includes a body 180, a pair of latches 182, and a plunger member 184. The body 180, the latches 182, and the plunger member 184 may be integrally formed from a single piece of material (e.g., via injection molding or another suitable operation). The body 180 is formed in an oval shape that matches the cross-sectional shape of the standpipe 112. As shown in FIG. 10, the pair of latches 182 engage a perimeter edge of the pair of openings 176 to retain the piston element 122 inside of the extension 170 and to set a maximum displacement of the piston element 122 within the extension 170. The latches 182 are disposed on opposing sides of the body 180 and extend radially away from the body 180.

The plunger member 184 is structured to sealingly engage with the bypass sealing seat 162 of the filter cartridge 102 (see FIG. 3). As shown in FIGS. 13-14, the plunger member 184 is engaged with an axial end 186 of the body 180 opposite from the latches 182 and extends axially away from the body 180. The plunger member 184 also includes a radial protrusion 187 at an outer end of the plunger member 184. In some embodiments, the plunger member 184 also includes a tapered edge at the outer end that matches the taper of the bypass sealing seat 162.

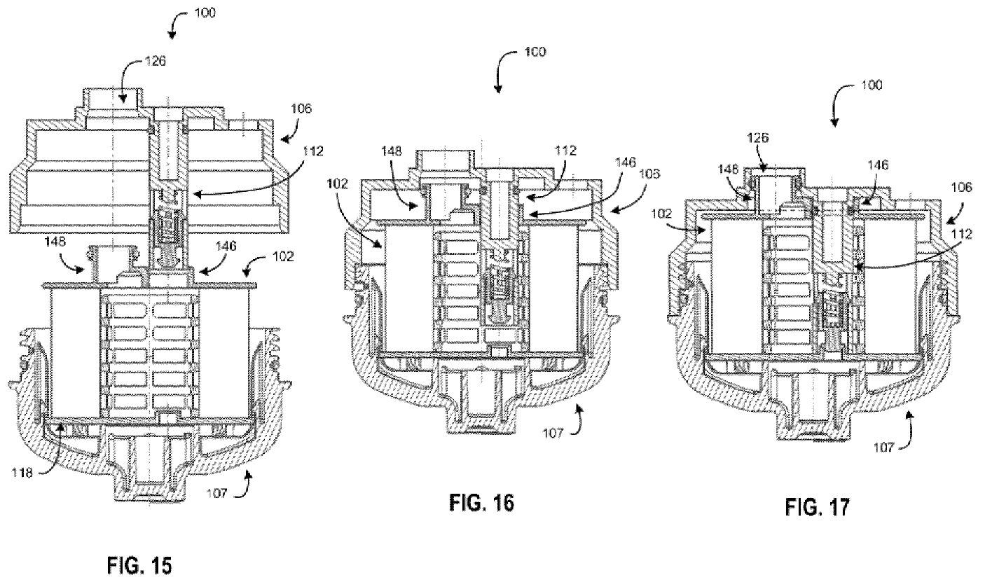

In at least one embodiment, the filter cartridge 102 is structured to engage the outlet port 126 and the standpipe 112 on the housing first portion 106 via unidirectional movement (e.g., axial movement) of the filter cartridge 102 relative to the housing first portion 106. FIGS. 15-17 show a method of installing the filter cartridge 102 into the housing 104, according to an embodiment. As shown in FIG. 15, the method includes engaging the filter cartridge 102 with the housing second portion 107 of the housing 104. For example, the method may include pressing the filter cartridge 102 toward the housing second portion 107 along an axial direction to engage the first endcap 118 with clips on the housing second portion 107.

The method includes rotating the housing second portion 107 and filter cartridge 102 to align the first conduit 146 and the second conduit 148 with the housing first portion 106 (e.g., to align the first conduit 146 and the second conduit 148 with respect to the standpipe 112 and outlet port 126, respectively). As shown in FIG. 15, the method of aligning the filter cartridge 102 includes rotating the housing second portion 107 to engage the standpipe 112 with the first conduit 146 located at a first radial position that is offset from a central axis of the filter cartridge 102. In some embodiments, aligning the first conduit with the standpipe includes aligning an oval-shaped opening of the first conduit 146 (e.g., that is defined by the first conduit 146) with an oval-shape formed by the standpipe 112. The method may further include inserting the standpipe 112 into the first conduit 146, for example by pressing the filter cartridge 102 axially toward the standpipe 112. Due to the oval shape used for the standpipe 112 and the first conduit 146, engaging the standpipe 112 with the first conduit 146 can also ensure alignment between the second conduit 148 and the outlet port 126 at a second radial position that is offset from the central axis of the filter cartridge (as the oval shaped interface prevents rotation of the standpipe 112 relative to the first conduit 146).

As shown in FIG. 16, after engaging the standpipe 112 with the first conduit 146, an axial force is applied to the housing second portion 107 to press the filter cartridge 102 toward the housing first portion 106 to engage the threaded interface of the housing second portion 107 and the housing first portion 106. As the filter cartridge 102 moves along the standpipe 112, the standpipe 112 guides the filter cartridge 102 toward the housing first portion 106 and maintains rotational alignment between the second conduit 148 and the outlet port 126. As shown in FIG. 17, after engaging the threads, a user may rotating the housing second portion 107 with respect to the filter cartridge 102 and the housing first portion 106 to sealingly engage the first conduit 146 and the second conduit 148 with the standpipe 112 and outlet port 126, respectively, and to engage the piston element 122 (e.g., the plunger member 184) of the bypass valve 108 with the first endcap 118 (e.g., with the bypass sealing seat 162).

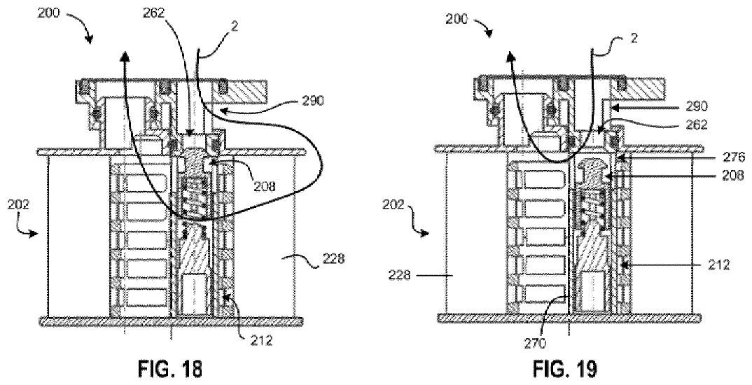

The combination of features shown in the example embodiment of FIGS. 1-17 should not be considered limiting, and a variety of alternatives and combinations are possible without departing from the inventive principles disclosed herein. For example, FIGS. 18-21 show a portion 200 of another example filtration system. The filtration system is structured to eliminate the need for a bypass sealing seat on an endcap of the filter cartridge. Instead, as shown in FIGS. 18-19, the bypass sealing seat 262 is integrated into the standpipe 212.

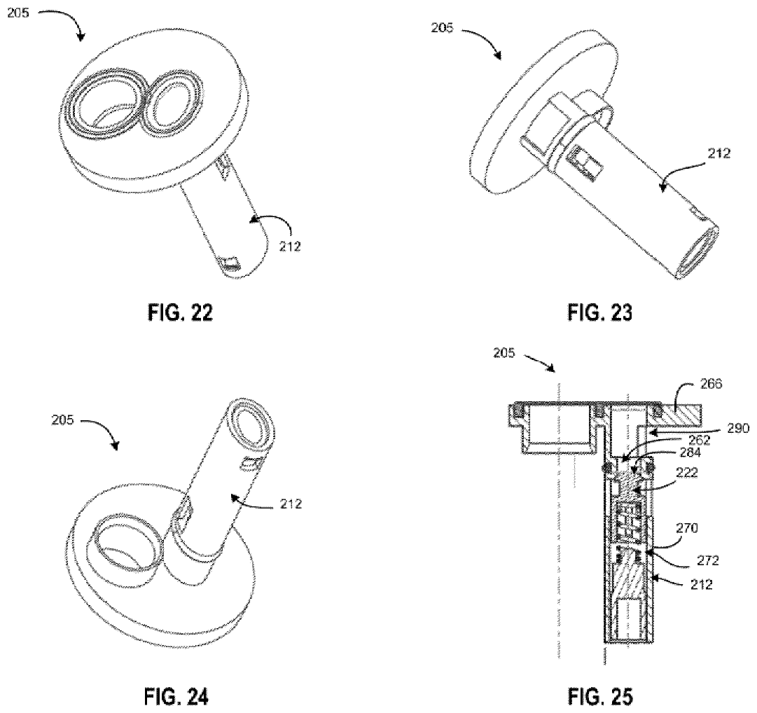

FIGS. 22-25 show various views of the standpipe 212 of the filtration system. The standpipe 212 may form part of an upper portion of the housing 204. In the embodiment of FIGS. 22-25, the standpipe 212 may form part of an intermediate assembly 205 between the housing and the filter cartridge 202 (e.g., a mounting flange that is sealingly engaged with the housing, the filter head, etc.). The intermediate assembly 205 may include sealing members (e.g., gaskets, O-rings, etc.) to sealingly engage the intermediate assembly 205 with other parts of the filtration system. In yet other embodiments, the standpipe 212 may form part of a filter head of the filtration system.

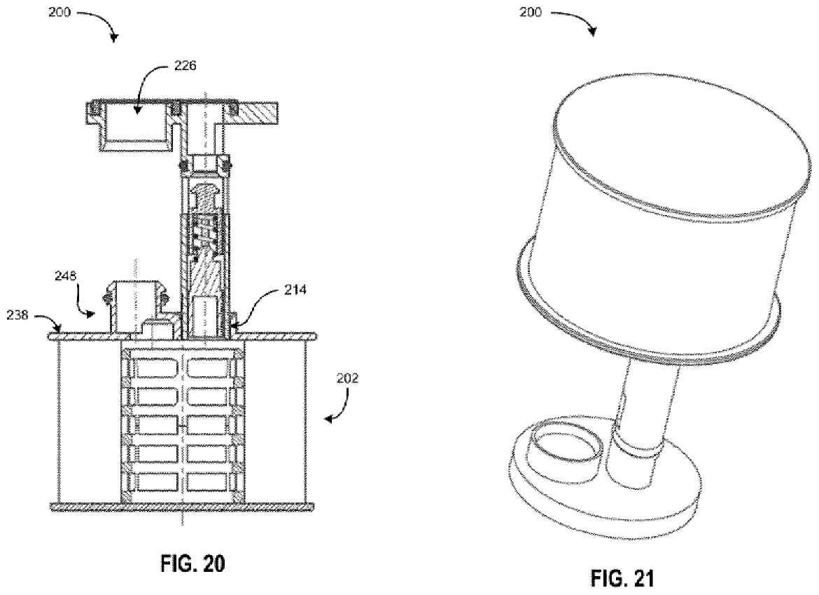

As shown in FIG. 25, the standpipe 212 comprises an extension 270 (e.g., a protrusion, etc.) having an oval-shaped cross-section that substantially matches (e.g., corresponds with, etc.) the shape of the standpipe opening 214 of the filter cartridge 202 (see FIG. 20). The bypass sealing seat 262 is disposed within the extension 270 at a proximal end of the standpipe 212. The piston element 222 is disposed within a hollow cavity 272 that is defined by the extension 270 and is arranged within the extension 270 so that the plunger member 284 is directed axially toward the bypass sealing seat 262.

As shown in FIG. 25, the extension 270 further includes side port 290 (e.g., opening, etc.) disposed axially between the bypass sealing seat 262 and the body base wall 266 of the intermediate assembly 205. As shown in FIGS. 18-19, the side port 290 is structured as an inlet port for the filtration system that directs fluid to the dirty side of the filter cartridge 202.

As shown in FIG. 19, in the event that the filter cartridge 202 (e.g., the media pack 228) becomes clogged, or the pressure drop across the filter cartridge 202 otherwise exceeds a pressure threshold, the bypass valve 208 switches automatically from the closed position to the open position. As shown in FIG. 19, when the bypass valve 208 is in the open position, the dirty fluid 2 may bypass the filter cartridge 202 (e.g., the media pack 228) via the standpipe 112 (e.g., via the pair of openings 276 disposed along a side of the extension 270). In this way, the bypass valve 208 can reduce the risk of over-pressurizing the filtration system and prevent oil starvation in the internal combustion engine that could result from reduced flow rates through the filter cartridge 202 (e.g., the media pack 228).

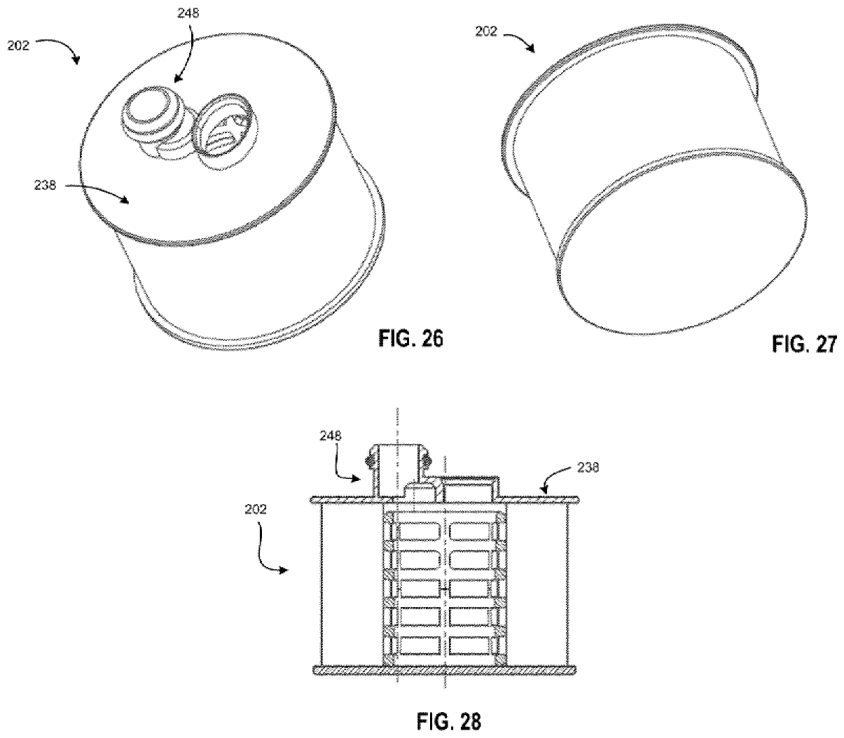

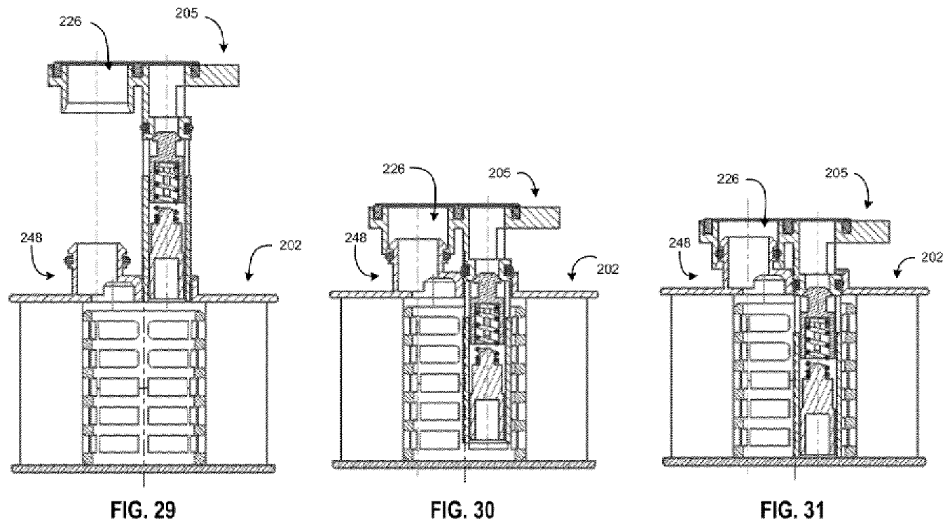

FIGS. 26-29 show various views of the filter cartridge 202 of the filtration system. In at least one embodiment, as shown in FIGS. 26 and 28, to facilitate assembly of the filter cartridge 202, the second conduit 248 of the second endcap 238 is tapered along an upper edge of the second conduit 248, which can help compensate for any angular misalignment (e.g., relative to an axial direction) between the second conduit 248 and the outlet port 226 during installation. FIGS. 29-31 show a method of installing the filter cartridge 202 onto the intermediate assembly 205. As shown in FIGS. 29-31, the taper along the upper edge of the second conduit 248 facilitates alignment between the second conduit 248 and the outlet port 226 as a user presses the filter cartridge 202 toward the intermediate assembly 205.

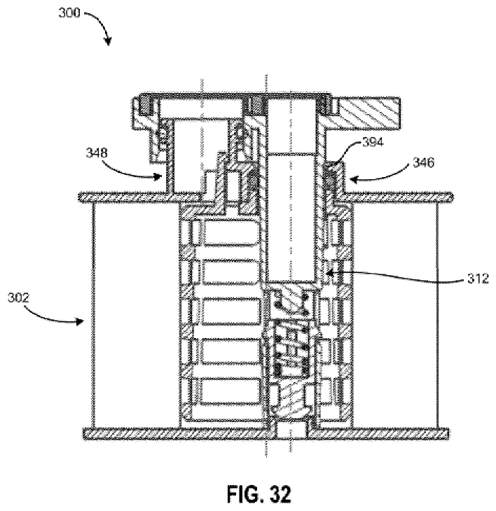

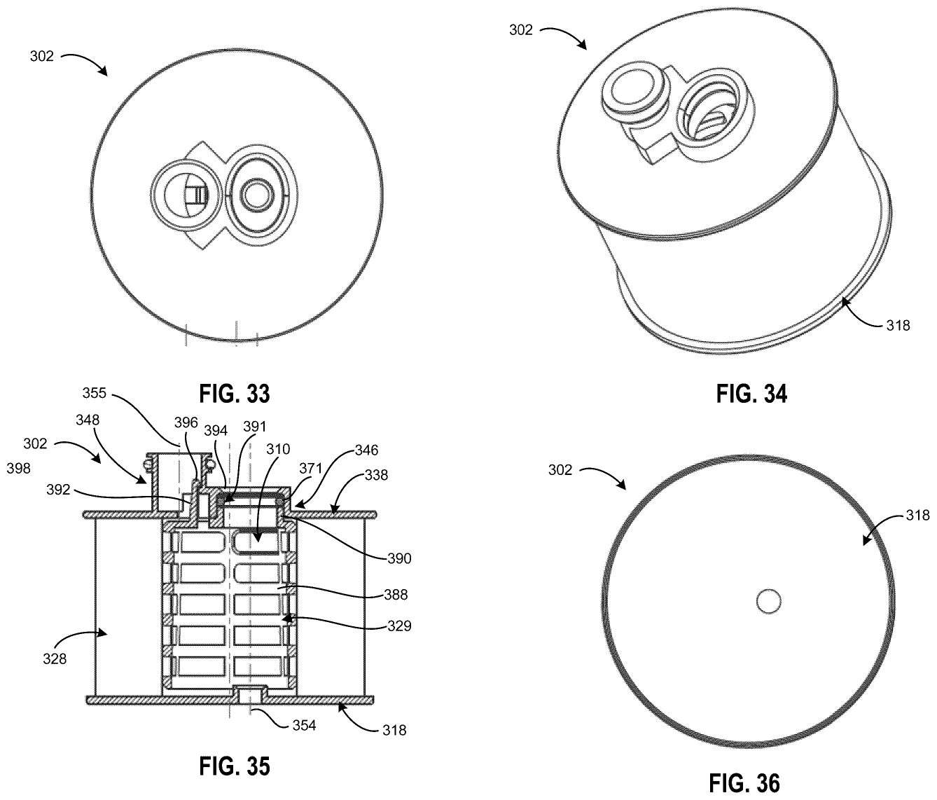

FIG. 32 shows a portion 300 of another example filtration system in which sealing members for both the first conduit 346 and the second conduit 348 are disposed on the filter cartridge 302 (instead of one or more sealing members being disposed on the housing or intermediate assembly). FIGS. 33-36 show various view of a filter cartridge 302 of the filtration system of FIG. 32. Portions of the filter cartridge 302, including the first endcap 318 are substantially the same as the filter cartridge 102 described with reference to FIGS. 6-9.

As shown in FIG. 35, the second endcap 338 is structured to engage with the support structure 329 of the filter cartridge 302 to receive and retain a standpipe sealing member 371 (e.g., O-ring, gasket, etc.) therein. The support structure 329 is disposed within the central cavity 310 of the media pack 328 and extends along an axial length of the central cavity 310. The support structure 329 includes a perforated center tube 388, a first extension 390, and a second extension 392. In one embodiment, the center tube 388 comprises a cylindrically-shaped extension. In other embodiments, the shape of the center tube 388 may be different. The first extension 390 and the second extension 392 are disposed on and engaged with a first tube end (e.g., first axial end, etc.) of the center tube 388 and extend axially away from the center tube 388.

As shown in FIG. 35, the support structure 329 extends axially into the first conduit 346 and the second conduit 348 of the second endcap 338. The support structure 329 and the first conduit 346 together define a groove 391 that extends along a circumferential direction with respect to a first conduit axis 354 of the first conduit 346. In particular, the first extension 390 of the support structure 329 comprises a cylindrically-shaped extension that is arranged coaxially with the first conduit 346. A cross-sectional shape of the first extension 390 matches a cross-sectional shape the first conduit 346 such that an outer perimeter of the first extension 390 engages an inner surface of the first conduit 346 when the first extension 390 is inserted into the first conduit 346. The first conduit 346 includes an upper ledge 394 that extends radially inward toward the first conduit axis 354. The ledge 394 is tapered to facilitate assembly with the standpipe 312 (see FIG. 32). As shown in FIG. 35, an upper end of the first extension 390 is spaced apart from the ledge 394 when the first extension 390 is fully inserted into the first conduit 346. A gap between the first extension 390 and the ledge 394 is sized to accommodate the standpipe sealing member 371 and to retain the standpipe sealing member 371 therein.

The support structure 329 is structured to connect to the second endcap 338 to secure the standpipe sealing member 371 to the filter cartridge 302. As shown in FIG. 35, the support structure 329 includes a clip 396 extending axially away from the center tube 388 and into the second conduit 348 and engaging the second conduit 348. In the embodiment of FIG. 35, the clip 396 comprises a latch (e.g., protrusion) disposed at a distal end of the second extension 392. The second extension 392 is flexible and clips, snaps, or otherwise engages a shelf 398 of the second conduit 348 to couple the support structure 329 to the second endcap 338. As shown in FIG. 35, the clip 396 of the second extension 392 engages a shelf or ledge that extends radially inward toward a second conduit axis 355 of the second conduit 348.

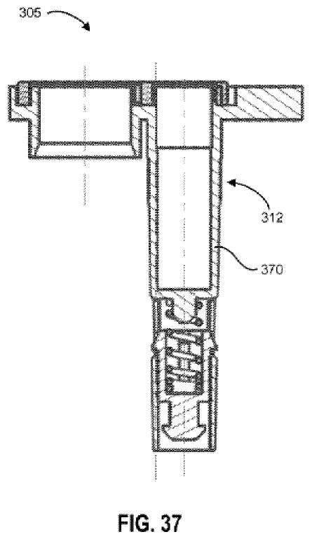

FIG. 37 shows the intermediate assembly 305 and the standpipe 312 of the filtration system of FIG. 32. The standpipe 312 includes a continuous (e.g., smooth, etc.) outer surface at a proximal end of the standpipe 312 to sealingly engage the standpipe 312 with the standpipe sealing member 371 of the filter cartridge 302 (see FIG. 35). As shown in FIG. 37, the standpipe 312 (an extension 370 of the standpipe 312) is tapered toward a distal end of the standpipe 312 to facilitate engagement between the standpipe 312 and the first conduit 346 (see FIG. 32).

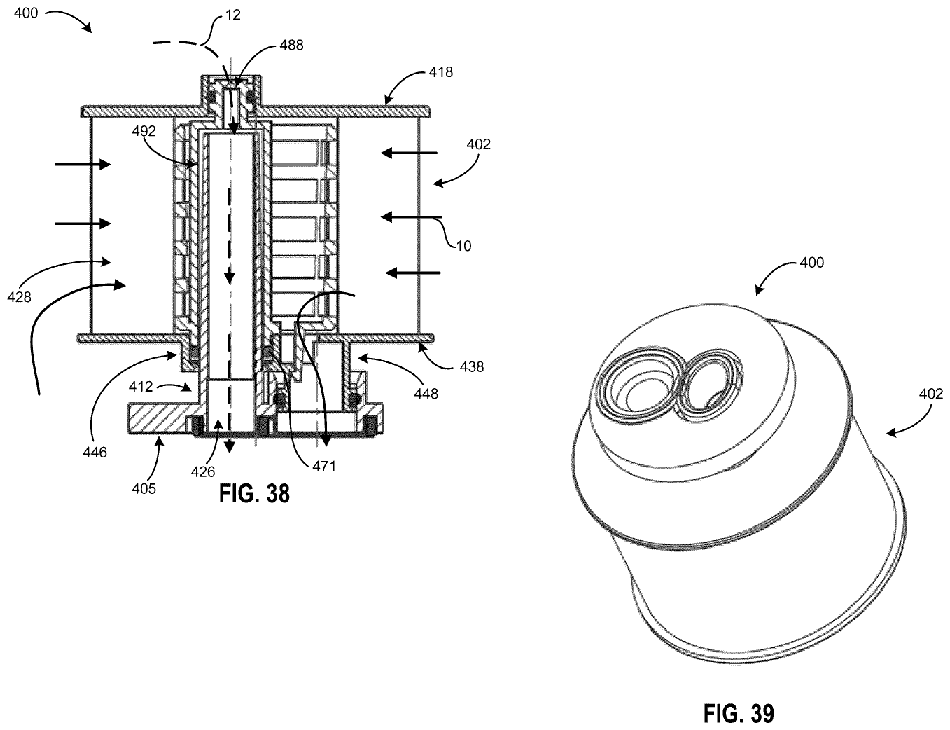

FIGS. 38-39 show a portion 400 of an example filtration system that is structured for use as a top-load module in a fuel filtration application. As shown in FIG. 38, the filtration system is arranged (e.g., on the engine, vehicle, etc.) so that the first conduit 446 and the second conduit 448 are oriented vertically downward toward a ground surface (e.g., so that the first endcap 418 is positioned above the second endcap 438).

The filter cartridge 402 is structured to automatically vent air from within the module back to a fuel tank or other fluid reservoir. As shown in FIG. 38, dirty fuel 10 entering the module passes through media pack 428 and exits the module through the first conduit 446 and an outlet port 426 of the intermediate assembly 405. Air 12 (and/or an air-fuel mixture) collected toward the top of the module, proximate to the first endcap 418, is automatically vented through an orifice 488 of the filter cartridge 402 and returns to the tank via a passage in the standpipe 412.

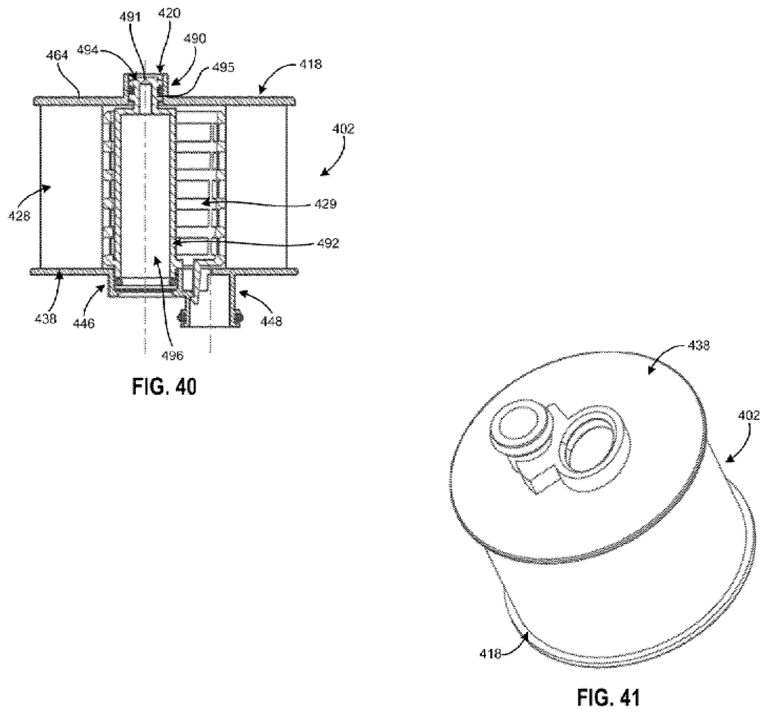

FIGS. 40-41 show the filter cartridge 402 of the filtration system. The design of the second endcap 438 is substantially the same as the design of the second endcap 338 described with reference to FIG. 35. As shown in FIG. 40, the first endcap 418 includes an air vent protrusion 490 that is engaged with a base wall 464 of the first endcap 418 and extends axially away from the base wall 464 and the media pack 428. The air vent protrusion 490 comprises a cylindrically-shaped extension defining a through-hole opening 420 therein. In other embodiments, the shape of the air vent protrusion 490 may be different. As shown in FIG. 40, the air vent protrusion 490 and through-hole opening 420 are arranged coaxially with the first conduit 446.

The support structure 429 of the filter cartridge 402 is structured to (i) engage with each of the first conduit 446, the second conduit 448, and the air vent protrusion 490; (ii) to meter a flow rate of the air 12 from the module to the tank; and (iii) to direct the air 12 toward the tank. As shown in FIG. 40, the support structure 429 includes a flow directing member 492 and an air vent member 494 at a first member end (e.g., first axial end, etc.) of the flow directing member 492. The flow directing member 492 extends axially between the first endcap 418 and the second endcap 438. In the embodiment of FIG. 40, the flow directing member 492 includes a cylindrically-shaped fluid conduit that defines a flow passage 496 therein.

The air vent member 494 includes a cylindrically-shaped protrusion 495 and an air vent 491 at an outer end of the protrusion 495. As shown in FIG. 40, the protrusion 495 extends axially away from the member end of the flow directing member 492 and sealingly engages the air vent protrusion 490. The air vent 491 includes an orifice (e.g., opening, hole, etc.) that meters the flow rate of air entering the flow directing member 492 based on a pressure difference between the dirty side of the filter cartridge 402 and the tank. The orifice may have a diameter within a range between approximately 0.3 mm and 0.5 mm, or another suitable value depending on the desired flow characteristics of the filtration system.

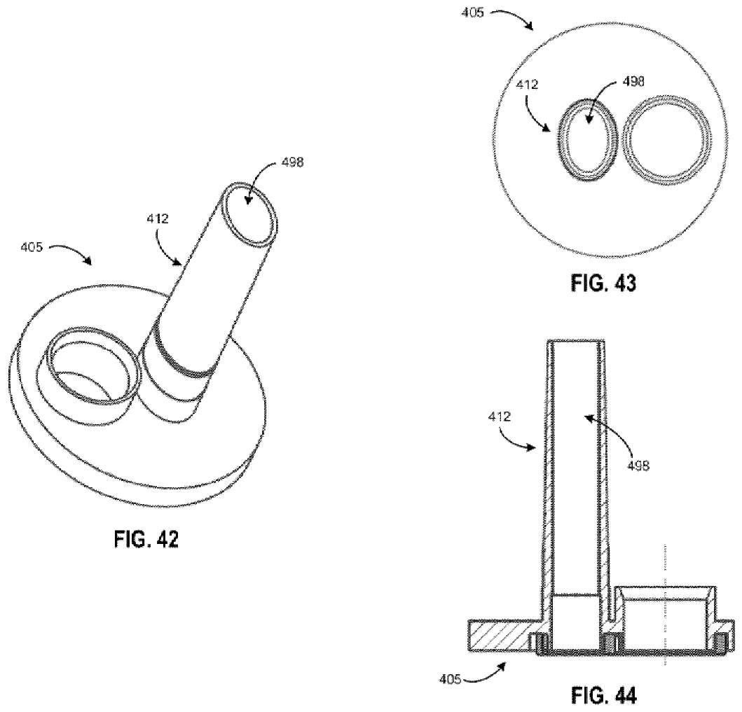

FIGS. 42-44 show various views of the intermediate assembly 405 of the filtration system. As shown in FIG. 44, the standpipe 412 defines a channel passage 498 leading to the return line for the tank. The standpipe 412, the first conduit 446, and the flow directing member 492 (see also FIG. 40) each have an oval cross-sectional shape, which facilitates assembly of the standpipe 412 into the flow passage 496 and prevents the use of non-genuine filter cartridges in the filtration system. As shown in FIG. 38, the standpipe sealing member 471 engages the flow directing member 492 to the standpipe 412 to prevent clean fuel from returning to the tank. The air vent member 494 sealingly engages the air vent protrusion 490 in the first endcap 418.

In some embodiments, the housing (e.g., head, intermediate assembly, etc.) of the filtration system includes an anti-drain back valve that selectively fluidly couples an inlet passageway of the housing to the filter cartridge depending on whether the engine is operating or not (e.g., depending on whether the pressure in the inlet passageway is greater than the pressure in the filter housing). In this way, the anti-drain back valve can ensure that fluid remains within the filtration cartridge and can be quickly provided to the engine at engine startup (e.g., without having to refill fluid into the filter housing).

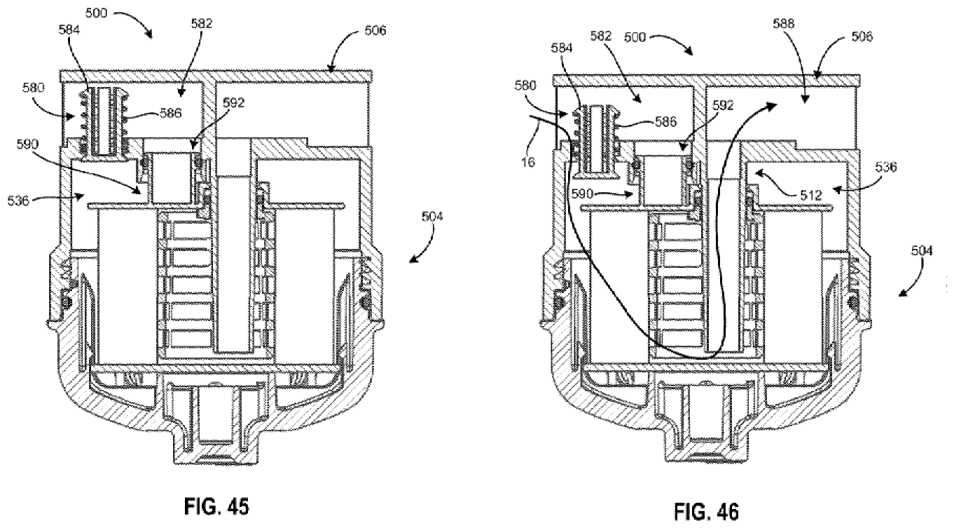

Referring to FIGS. 45-46, an example filtration system 500 is shown that include an anti-drain back valve 580. The anti-drain back valve 580 is disposed in a first portion 506 of the housing 504, along an inlet passageway 582 of the housing first portion 506 that directs dirty fluid into a hollow interior 536 of the housing 504. The anti-drain back valve 580 includes a movable member 584 that is slidably engaged with the housing first portion 506, and a spring element 586 that maintains the movable member 584 seated along a lower wall of the inlet passageway 582.

As shown in FIGS. 45-46, the anti-drain back valve 580 is configured to switch from a closed position to an open position to allow fluid to flow through the filtration system 500 under an applied pressure across the anti-drain back valve 580 (e.g., when the engine is operating). In the open position, as shown in FIG. 46, fluid 16 passing through the anti-drain back valve 580 is directed through the filter cartridge 502 and through the standpipe 512 back into an outlet passageway 588 of the housing first portion 506.

In at least one embodiment, the filter cartridge 502 is structured to allow dirty fluid to bypass from the inlet passageway 582 into the hollow interior 536 during service events (e.g., during replacement of the filter cartridge 502). Among other benefits, bypassing the fluid from the inlet passageway 582 during service events can reduce the amount of dirty fluid remaining in the filtration system after installing a new filter cartridge, which can improve the life of the engine, gear box, E-axle, and/or other components of the engine system.

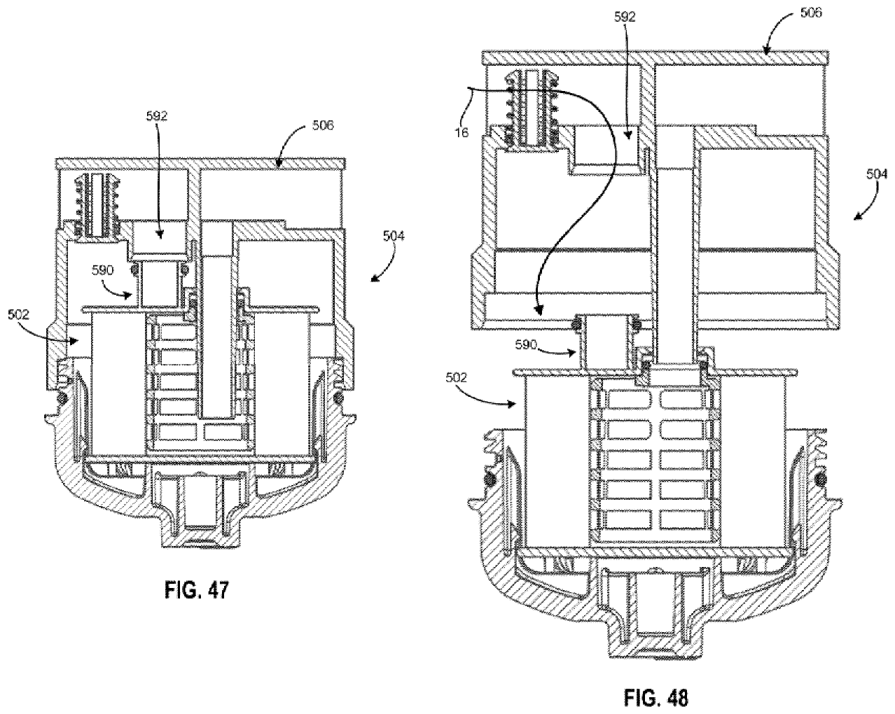

As shown in FIGS. 45-46, the filter cartridge 502 includes a plug 590 that is structured to sealingly engage with a bypass port 592 in the housing first portion 506 that fluidly couples the inlet passageway 582 of the housing first portion 506 to the hollow interior 536 of the housing 504. As shown in FIGS. 47-48, during service events, the filter cartridge 502 is separated from the housing first portion 506, which disengages the plug 590 from the bypass port 592 to allow dirty fluid 16 from the inlet passageway 582 to drain out of the housing 504.

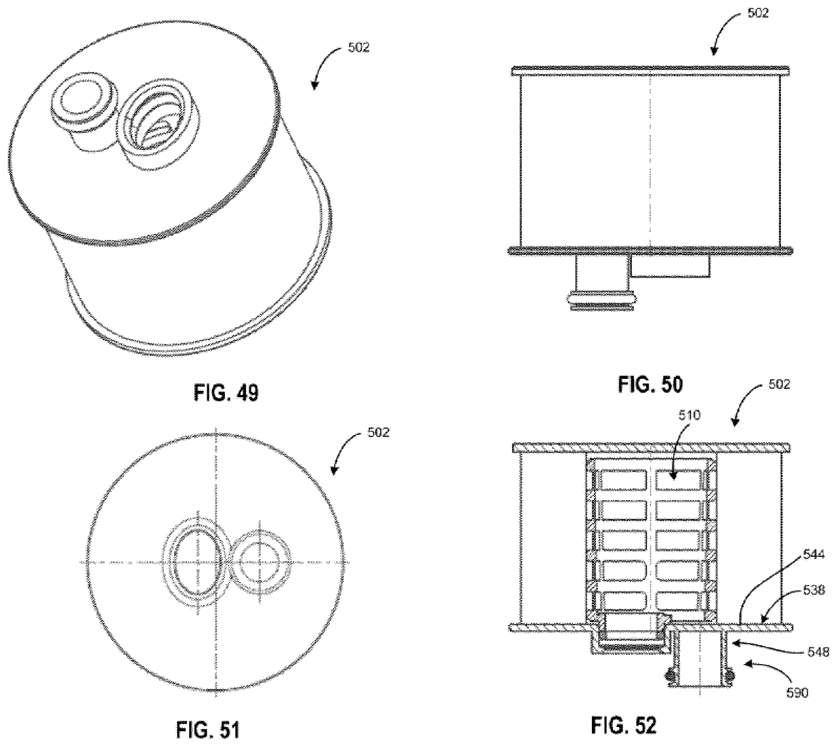

FIGS. 49-52 show various views of the filter cartridge 502 of the filtration system 500. As shown in FIG. 52, the plug 590 is formed by the second conduit 548 of the second endcap 538. The second conduit 548 extends axially away from a base wall 544 of the second endcap 538 defining a fluid passage therein. The fluid passage is blocked off where the second conduit 548 engages the base wall 544. In other embodiments, the second conduit 548 is blocked off at a distal end of the second conduit 548 or at any other location between the distal end and a central cavity 510 of the filter cartridge 502.

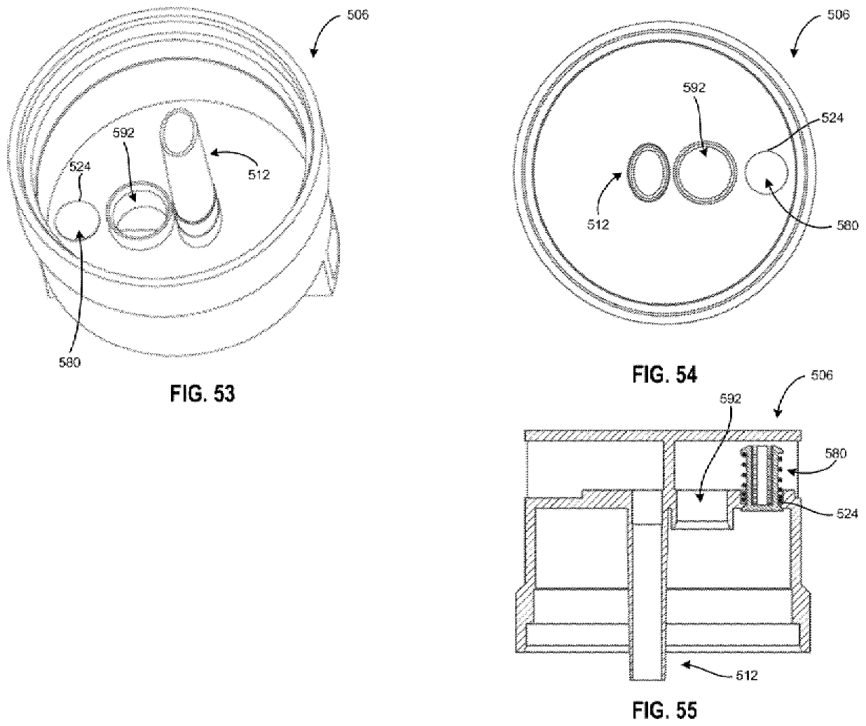

FIGS. 53-55 show various views of the housing first portion 506 of the housing 504. The housing first portion 506 includes the standpipe 512, the bypass port 592 and an inlet port 524 (e.g., at the anti-drain back valve 580). As with other embodiments described herein, the standpipe 512 has an oval cross-sectional shape, which can facilitate alignment between the bypass port 592 of the housing first portion 506 and the second conduit 548 of the filter cartridge 502.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given angle or other value) are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination

1. A filter cartridge, comprising:
a media pack defining a central cavity;
a first endcap coupled to a first pack end of the media pack;
a second endcap coupled to a second pack end of the media pack, the second endcap comprising:
a first conduit extending axially away from the media pack and fluidly coupled to the central cavity, the first conduit defining a standpipe opening that is sized to receive a standpipe therein; and
a second conduit extending axially away from the media pack and spaced apart from the first conduit, a first conduit axis of the first conduit and a second conduit axis of the second conduit each radially offset from a central axis of the central cavity.

2. The filter cartridge of claim 1, wherein the second conduit is fluidly coupled to the central cavity separately from the first conduit.

3. The filter cartridge of claim 1, wherein the first endcap includes a through-hole opening that is arranged coaxially with the first conduit.

4. The filter cartridge of claim 1, wherein the first conduit defines an oval-shaped opening extending through the second endcap.

5. The filter cartridge of claim 1, further comprising a support structure comprising a center tube disposed within the central cavity and extending axially into the first conduit, the support structure and the first conduit together defining a groove that extends along a circumferential direction with respect to the first conduit axis of the first conduit.

6. The filter cartridge of claim 1, further comprising a support structure comprising a center tube disposed within the central cavity and a clip extending axially away from the center tube and into the second conduit and engaging the second conduit.

7. The filter cartridge of claim 1, wherein the second conduit is blocked off from fluid flow.

8. The filter cartridge of claim 1, wherein a portion of an outer wall of the second conduit extends radially outwardly beyond an inner perimeter of the media pack.

9. The filter cartridge of claim 1, wherein the first endcap includes a bypass sealing seat that extends toward the second endcap, the bypass sealing seat defining a through-hole opening that extends through the first endcap.

10. The filter cartridge of claim 1, further comprising a support structure comprising a center tube disposed within the central cavity, the support structure including an air vent member comprising an orifice, wherein the first endcap includes an air vent protrusion that extends axially away from the media pack, the air vent member sealingly engaged with the air vent protrusion.

11. A filtration system, comprising:
a standpipe; and
a filter cartridge comprising:
a media pack defining a central cavity;
a first endcap disposed at a first pack end of the media pack; and
a second endcap disposed at a second pack end of the media pack, the second endcap defining:
a first opening; and
a second opening spaced radially apart from the first opening, the standpipe extending through the second opening and into the central cavity, the standpipe engaging with the first endcap to form one of a bypass valve or an air vent.

12. The filtration system of claim 11, wherein a first central axis of the first opening and a central axis of the second opening are each radially offset from a central axis of the central cavity.

13. The filtration system of claim 11, wherein a distal end of the standpipe is disposed within the central cavity, the standpipe tapered between a first radius at a proximal end of the standpipe to a second radius at the distal end that is smaller than the first radius.

14. The filtration system of claim 11, wherein the second opening and the standpipe are both oval-shaped.

15. The filtration system of claim 11, wherein the standpipe is part of a housing, the housing defining an inlet port and an outlet port, wherein the second endcap further comprises a conduit that defines the first opening, the conduit extending into the inlet port when the filter cartridge is installed onto the housing.

16. The filtration system of claim 11, wherein the first endcap defines a bypass sealing seat for the bypass valve, and wherein a distal end of the standpipe at least partially surrounds the bypass sealing seat.

17. The filtration system of claim 11, wherein the first endcap defines a bypass sealing seat for the bypass valve, wherein the bypass valve including a piston element disposed at least partially within the standpipe, the piston element including a plunger member configured to sealingly engage with the bypass sealing seat.

18. The filtration system of claim 11, wherein the first endcap comprises an air vent protrusion, the filter cartridge further comprising a support structure including:
a flow directing member extending axially between the first endcap and the second endcap, the flow directing member defining a flow passage therein; and
an air vent member at a first member end of the flow directing member, the air vent member sealingly engaged with the air vent protrusion, wherein the standpipe extends into the flow passage.

19. A method of installing a filter cartridge into a housing, comprising:
aligning a first conduit of the filter cartridge located at a first radial position that is offset from a central axis of the filter cartridge with a standpipe of the housing;
inserting the standpipe into the first conduit and into a central cavity of the filter cartridge; and
inserting a second conduit of the filter cartridge located at a second radial position that is offset from the central axis of the filter cartridge into an outlet port of the housing.

20. The method of claim 19, wherein aligning the first conduit with the standpipe comprises aligning an oval-shaped opening of the first conduit with an oval-shape formed by the standpipe.

21. The method of claim 19, wherein inserting the standpipe into the first conduit comprises engaging a piston element disposed within the standpipe with an endcap of the filter cartridge that is located on an opposite end of the filter cartridge as the first conduit.
